(19) United States
(12) Patent Application Publication
(10) Pub. No.: US 2010/0098247 A1
(43) Pub. Date: Apr. 22, 2010

(54) Method, Apparatus And Computer Program Product For Generating An Encryption Key And An Authentication Code Key Utilizing A Generic Key Counter

(75) Inventor: Jan Erik Suumaki, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/254,602

(22) Filed: Oct. 20, 2008

(51) Int. Cl. H04L 9/00

(52) U.S. Cl. 380/44

(57) ABSTRACT

A method, apparatus and computer program product are provided that relate to encryption and authentication techniques. An apparatus may include a processor configured to define a generic key counter. The processor may also be configured to generate an encryption key at least partially based upon the generic key counter. The processor may also be configured to generate an authentication code key that is at least partially based upon the same generic key counter. The processor may further be configured to update the encryption key and the authentication code in accordance with a common time schedule. A corresponding method and computer program product may also be provided.

### TECHNOLOGICAL FIELD

Embodiments of the present invention relate generally to encryption technology and, more particularly, relates to the generation of an encryption key and an authentication code key utilizing a generic key counter.

### BACKGROUND

The encryption of messages is widely employed for security, authentication, integrity and other purposes. For example, the communication signals exchanged between mobile stations and base stations are commonly encrypted. In order to provide the desired encryption, one or more encryption keys may be generated. These encryption keys will then be used by the sender to encrypt a message prior to transmission and will correspondingly be used by the intended recipient to decrypt the message following transmission. As a result of the encryption of the message, only the communication devices that have the appropriate encryption keys, such as a public and private key pair or shared keys, can decrypt the message. In addition to encryption keys, authentication code keys can also be employed in order to protect the integrity of the messages exchanged between communication devices.

While encryption keys and authentication code keys are widely utilized, the generation and maintenance of the encryption keys and authentication code keys can require a meaningful amount of processing resources for each of the communication devices, such as a mobile station and a base station or other access point with which the mobile station is in communication. In this regard, one factor that causes the consumption of meaningful processing resources by each of the communication devices is that a number of the encryption keys and the authentication code keys are based upon different parameters, each of which must be maintained and updated over time. Additionally, the procedures for maintaining and updating the encryption keys and the authentication code keys including the frequency with which the encryption keys and authentication code keys are to be updated and the events that trigger such updating generally differ, thereby adding to the processing resources that must be dedicated to the generation and maintenance of the encryption keys and authentication code keys.

By way of example, the mobile Worldwide Interoperability for Microwave Access (WiMAX) 802.16e specification defines a variety of encryption keys and authentication code keys that must be individually generated and maintained. Among others, the 802.16e specification requires transmission encryption keys (TEKs) and group TEKs (GTEKs) for encryption purposes. Additionally, the 802.16e specification requires the generation and maintenance of cipher-based message authentication code (CMAC) keys. However, the TEKs and the CMAC keys are maintained in different manners with updates being triggered by different situations and at different frequencies, thereby increasing the processing resources required to generate and maintain the TEKs and the CMAC keys. For example, although an authorization key (AK) is updated after reauthentication (which occurs by default at least every 7 days) which, in turn, causes the execution of a key update procedure in which the TEKs and CMAC keys are both updated, a TEK update procedure is executed at least every 12 hours. In the TEK update procedure, the TEKs are updated, but not the CMAC keys. Further, the TEKs are updated in instances in which a mobile station is handed over to another base station unless a specific handover optimization routine is employed. The specific handover optimization routine where TEKs are reused in a target base station is defined by the 802.16e specification, but is not required by the Mobile System Profile (MSP) and is, therefore, not necessarily employed. CMAC keys are also generally updated in instances in which a mobile station is handed over to another base station.

Although the variations in the generation and maintenance of the TEKs and the CMAC keys adds to the processing complexity necessitated by the 802.16e specification, a newer evolution version of mobile WiMAX is being developed as defined by the 802.16m specification in which the differences between the generation and maintenance of the TEKs and the CMAC keys may become more problematic. In this regard, the media access control (MAC) management messages may be either encrypted utilizing TEKs or, instead, subjected only to integrity protection utilizing CMAC keys. Since the manner and timing of the generation and maintenance of the TEKs and CMAC keys differ, however, the security provided by the alternative use of the TEKs and the CMAC keys for MAC management messages may therefore also disadvantageously differ.

As such, it may be desirable to provide a technique for the generation and maintenance of encryption keys and authentication codes that could potentially reduce the requisite processing resources. In addition, it may be desirable to develop a technique for generating and maintaining encryption keys and authentication codes in a more consistent manner such that the resulting security provided by use of either the encryption keys or the authentication codes would be more similar.

### BRIEF SUMMARY OF SOME EXAMPLES OF THE INVENTION

A method, apparatus and computer program product are therefore provided to enable the generation of encryption keys and authentication code keys that are at least partially based upon the same generic key counter. As such, the number of parameters that must be defined and maintained in order to generate the encryption keys and authentication code keys may be reduced, thereby potentially reducing the processing resources required to generate the encryption keys and the authentication code keys. In one embodiment, a method, apparatus and computer program product may also be provided that permit the encryption keys and authentication code keys to be concurrently updated such that the security provided by use of either the encryption keys or the authentication code keys may be more similar.

In one embodiment, a method is provided that defines a generic key counter and then generates both an encryption key and an authentication code key that are each at least partially based upon the generic key counter. In one embodiment, the generation of at least the encryption key may also be at least partially based upon the nonce as well as the generic key counter. Furthermore, the method of one embodiment may also define a group generic key counter and generate a group encryption key that is at least partially based upon the group generic key counter and nonce.

The method of one embodiment may utilize the generic key counter to define first and second generic key counter values. As such, the method of this embodiment may also generate first and second encryption keys at least partially based upon the first and second generic key counter values, respectively, as well as at least one authentication code key that is also at least partially based upon one of the first and second generic key counter values. In one embodiment, first and second authentication code keys are also generated at least partially based upon the first and second generic key counter values, respectively. In instances in which a handover is to occur, the method of one embodiment may define first and second generic key counters for each target base station.

The method of one embodiment may also concurrently update the encryption key and the authentication code key by redefining the generic key counter and then concurrently regenerating the encryption key and the authentication code key at least partially based upon the generic key counter as redefined. In this embodiment, the concurrent updating of the encryption key and the authentication code key may occur in conjunction with a key update procedure and/or a handover procedure. Further, the method of one embodiment may initialize the generic key counter in conjunction with a reauthentication procedure.

In other embodiments of the present invention, a corresponding apparatus and a corresponding computer program product may be provided that are configured to perform the foregoing functions. In this regard, an apparatus of one embodiment may include a processor configured to define a generic key counter and also configured to generate an encryption key and an authentication code key that are each at least partially based upon the same generic key counter. In accordance with another embodiment, an apparatus is provided that includes means for defining a generic key counter, means for generating an encryption key at least partially based upon the generic key counter and means for generating an authentication code key that is also at least partially based upon the same generic key counter. Further, a computer program product may be provided according to another embodiment that includes at least one computer-readable storage medium having computer-executable program code instructions stored therein. The computer-executable program code instructions include program code instructions configured to define a generic key counter, program code instructions configured to generate an encryption key at least partially based upon the generic key counter and program code instructions configured to generate an authentication code key that is also at least partially based upon the same generic key counter.

As such, embodiments of the method, apparatus and computer program product may permit an encryption key and an authentication code key to be generated based upon the same generic key counter, thereby providing potentially greater uniformity between the encryption keys and the authentication code keys as well as potentially reducing the processing resources that are consumed by the generation and maintenance of the encryption keys and authentication code keys. Also, embodiments of the method, apparatus and computer program product may only transmit a portion of the generic key counter, such as the n-least significant bits, over the air, thereby making it more difficult for unintended recipients to discern the generic key counter. Further, some embodiments of the method, apparatus and computer program product may permit the encryption key and the authentication code key to be updated in accordance with the same time schedule, thereby potentially further increasing the uniformity between the generation and maintenance of an encryption key and an authentication code key.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a schematic block diagram of a system for permitting the generation of an encryption key and an authentication code key at least partially based upon the same generic key counter in accordance with embodiments of the present invention;

FIG. 2 is a schematic block diagram of an apparatus for generating an encryption key and an authentication code key that are at least partially based upon the same generic key counter in accordance with embodiments of the present invention;

FIG. 3 is a schematic block diagram of another apparatus for generating an encryption key and an authentication code key that are at least partially based upon the same generic key counter in accordance with embodiments of the present invention;

FIG. 4 is a signal flow diagram illustrating a sequence of signals exchanged during an initial authentication procedure in accordance with embodiments of the present invention;

FIG. 5 is a signal flow diagram illustrating a sequence of signals exchanged during a re-authentication procedure in accordance with embodiments of the present invention;

FIG. 6 is a signal flow diagram illustrating a sequence of signals exchanged during a key update procedure in accordance with embodiments of the present invention;

FIG. 7 is a signal flow diagram illustrating a sequence of signals exchanged during a handover procedure in accordance with embodiments of the present invention;

FIG. 8 is a signal flow diagram illustrating a sequence of signals exchanged during a re-entry following a connection loss procedure in accordance with embodiments of the present invention;

FIG. 9 is a signal flow diagram illustrating a sequence of signals exchanged during the process of handing over from a base station operating in accordance with a first specification to a base station operating in accordance with a second specification and then again to a base station operating in accordance with the first specification in accordance with embodiments of the present invention; and

FIG. 10 is a flowchart of the operations performed in accordance with embodiments of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

In accordance with embodiments of the present invention, an apparatus, such as each of a mobile station and a base station, may define a generic key counter and then utilize the generic key counter in the generation of an encryption key for encryption purposes and an authentication code key for integrity purposes. By way of illustration but not of limitation, embodiments of the present invention may utilize a generic key counter to generate the TEKs and the CMAC keys utilized in WiMAX, such as in accordance with the 802.16m specification. However, other embodiments of the present invention may generate encryption keys and authentication code keys at least partially based upon a common generic key counter to secure communications conducted in accordance with other protocols or the like.

Although embodiments of the present invention may support secure communications between various types of communications devices including both mobile and fixed devices, one example of a system including a mobile station (MS) 10 that could benefit from embodiments of the present invention is depicted in FIG. 1. While embodiments of the mobile station may be illustrated and hereinafter described for purposes of example, other types of terminals, such as portable digital assistants (PDAs), pagers, mobile televisions, mobile telephones, gaming devices, laptop computers, cameras, video recorders, audio/video player, radio, global positioning system (GPS) devices, or any combination of the aforementioned, and other types of voice and text communications systems, can employ embodiments of the present invention. Furthermore, devices that are not mobile may also employ embodiments of the present invention.

One or more communication terminals such as the mobile station 11 may be in communication with each other via a network 12 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In this regard, the various access points and base stations will be hereinafter generically referenced as base stations (BSs) 14. By directly or indirectly connecting the mobile station and other communication devices to the network, the mobile station and the other communication devices may be enabled to communicate with the other devices or each other, for example, according to numerous communication protocols including Hypertext Transfer Protocol (HTTP) and/or the like, to thereby carry out various communication or other functions.

The network 12 may include a collection of various different nodes, devices or functions that may be in communication with each other via corresponding wired and/or wireless interfaces. For example, the network may include an authenticator 16 that is in communication with the base station 14 for supporting encrypted communications involving the base station. In this regard, various network entities may serve as the authenticator, but in one embodiment, the authenticator is embodied by one or more gateways that are disposed in communication with the base station via the network. As such, the illustration of FIG. 1 should be understood to be an example of a broad view of certain elements of the system and not an all inclusive or detailed view of the system or the network. Although not necessary, in some embodiments, the network may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

With respect to the embodiment of FIG. 1, a mobile station 10 may be configured to communicate with a base station 14 via a wireless access mechanism, such as a wireless local area network (WLAN), WiMAX or the like. As described below, the mobile station and the base station may each operate in accordance with embodiments of the present invention so as to define a generic key counter and then locally utilize the generic key counter in the generation of an encryption key and an authentication code key. The encryption key and authentication code key can then be employed to secure communications between the mobile station and the base station.

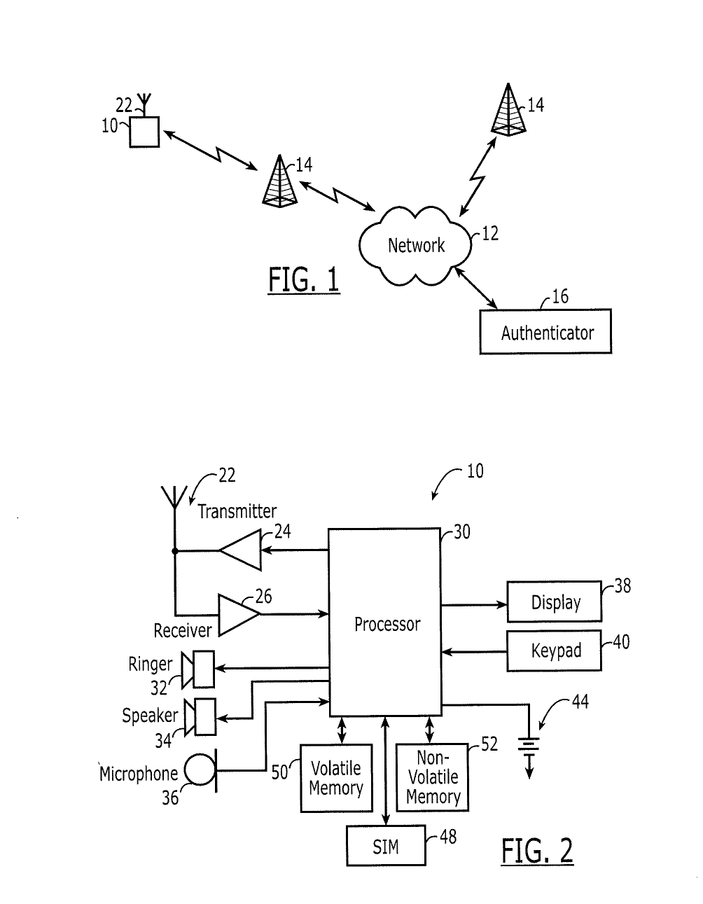

Although the mobile station 10 may be configured in various manners, one example of a mobile station that could benefit from embodiments of the invention is depicted in the block diagram of FIG. 2. While several embodiments of the mobile station 12 may be illustrated and hereinafter described for purposes of example, other types of mobile stations, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communications devices, may employ embodiments of the present invention. As described, the mobile station can include various means for performing one or more functions in accordance with embodiments of the present invention, including those more particularly shown and described herein. It should be understood, however, that a mobile station may include alternative means for performing one or more like functions, without departing from the spirit and scope of the present invention.

The mobile station 10 may include an antenna 22 (or multiple antennas) in operable communication with a transmitter 24 and a receiver 26. The mobile station may further include an apparatus, such as a processor 30, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile station may be capable of operating with one or more air interface standards, communication protocols, modulation types, and access types. By way of illustration, the mobile station may be capable of operating in accordance with any of a number of first, second, third and/or fourth-generation communication protocols or the like. For example, the mobile station may be capable of operating in accordance with WiMAX and/or in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved-universal terrestrial radio access network), with fourth-generation (4G) wireless communication protocols or the like.

It is understood that the apparatus, such as the processor 30, may include circuitry implementing, among others, audio and logic functions of the mobile station 10. The processor may be embodied in a number of different ways. For example, the processor may be embodied as various processing means such as a processing element, a coprocessor, a controller or various other processing devices including integrated circuits such as, for example, an ASIC (application specific integrated circuit), an FPGA (field programmable gate array), a hardware accelerator, and/or the like. In an example embodiment, the processor may be configured to execute instructions stored in a memory device or otherwise accessible to the processor. As such, the processor may be configured to perform the processes, or at least portions thereof, discussed in more detail below with regard to FIGS. 4-9. The processor may also include the functionality to convolutionally encode and interleave message and data prior to modulation and transmission. The processor may additionally include an internal voice coder, and may include an internal data modem.

The mobile station 10 may also comprise a user interface including an output device such as an earphone or speaker 34, a ringer 32, a microphone 36, a display 38, and a user input interface, which may be coupled to the processor 30. The user input interface, which allows the mobile station to receive data, may include any of a number of devices allowing the mobile station to receive data, such as a keypad 40, a touch display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the mobile station may include an interface device such as a joystick or other user input interface. The mobile station may further include a battery 44, such as a vibrating battery pack, for powering various circuits that are used to operate the mobile station, as well as optionally providing mechanical vibration as a detectable output.

The mobile station 10 may further include a user identity module (UIM) 48, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile station may be equipped with memory. For example, the mobile station may include volatile memory 50, such as volatile Random Access Memory (RAM) including a cache area for the temporary storage of data. The mobile station may also include other non-volatile memory 52, which may be embedded and/or may be removable. The non-volatile memory may additionally or alternatively comprise an electrically erasable programmable read only memory (EEPROM), flash memory or the like. The memories may store any of a number of pieces of information, and data, used by the mobile station to implement the functions of the mobile station. For example, the memories may include an identifier, such as an international mobile equipment identification (IMEI) code, capable of uniquely identifying the mobile station. Furthermore, the memories may store instructions for determining cell id information. Specifically, the memories may store an application program for execution by the processor 30, which determines an identity of the current cell, i.e., cell id identity or cell id information, with which the mobile station is in communication.

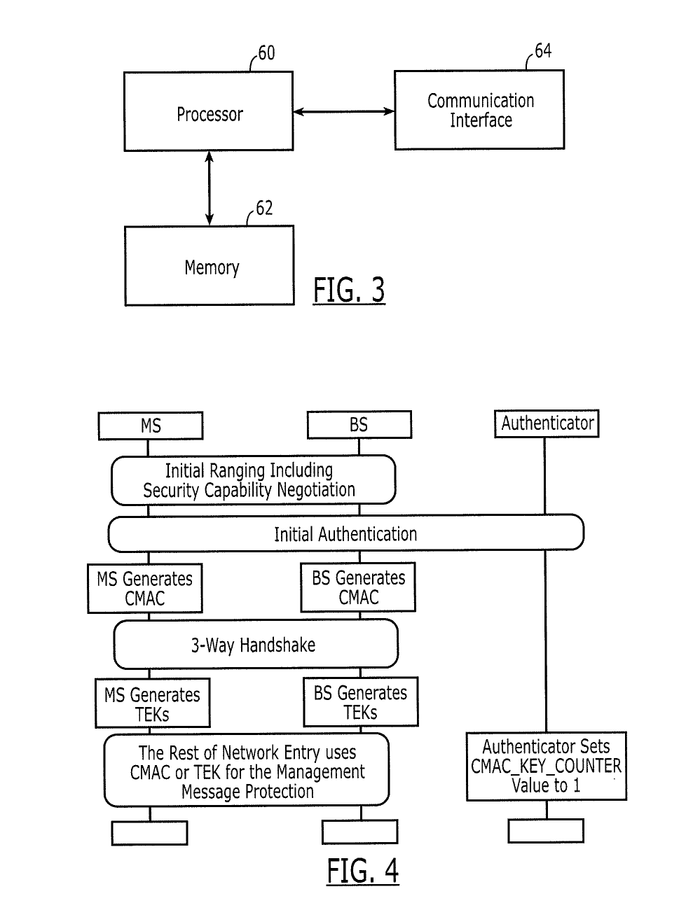

While a mobile station 10, such as depicted in FIG. 2, may employ embodiments of the present invention, other devices, such as a base station 14, that is in communication with the mobile station may also employ embodiments of the present invention. Referring to FIG. 3, for example, a block diagram of an entity capable of operating as a base station is shown in accordance with one embodiment of the present invention. The entity capable of operating as a base station includes various means for performing one or more functions in accordance with embodiments of the present invention, including those more particularly shown and described herein. It should be understood, however, that one or more of the entities may include alternative means for performing one or more like functions, without departing from the spirit and scope of the present invention.

As shown, a base station 14 may include means, such as a processor 60 for performing or controlling its various functions. The processor may be embodied in a number of different ways. For example, the processor may be embodied as various processing means such as a processing element, a coprocessor, a controller or various other processing devices including integrated circuits such as, for example, an ASIC (application specific integrated circuit), an FPGA (field programmable gate array), a hardware accelerator, and/or the like. In an example embodiment, the processor may be configured to execute instructions stored in the memory or otherwise accessible to the processor. As such, the processor may be configured to perform the processes, or at least portions thereof, discussed in more detail below with regard to FIGS. 4-9.

In one embodiment, the processor 60 is in communication with or includes memory 62, such as volatile and/or non-volatile memory that stores content, data or the like. For example, the memory may store content transmitted from, and/or received by, the base station. Also for example, the memory may store software applications, instructions or the like for the processor to perform steps associated with operation of the base station in accordance with embodiments of the present invention. In particular, the memory may store software applications, instructions or the like for the processor to perform the operations described above and below with regard to FIGS. 4-9 for generating an encryption key and an authentication code key at least partially based upon a common generic key counter.

In addition to the memory 62, the processor 60 can also be connected to at least one interface or other means for transmitting and/or receiving data, content or the like. In this regard, the interface(s) can include at least one communication interface 64 or other means for transmitting and/or receiving data, content or the like, such as between the base station 14 and the mobile station 10, such as in accordance with a wireless access mechanism such as WiMAX, and/or between the base station and the network 12.

In one embodiment, two or more devices that are in communication with one another, such as a mobile station 10 as shown in FIG. 2 and a base station as shown in FIG. 3, may employ embodiments of the method, apparatus and computer program product to generate an encryption key and authentication code key based upon the same generic key counter, thereby permitting communications therebetween to be secured in an efficient and a uniform manner. In this regard, the method, apparatus and computer program product of embodiments of the present invention may generate an encryption key and authentication code key based upon the same generic key counter in various situations, such as during initial network entry, during re-authentication, during a key update procedure, during a hand-over procedure, during re-entry following the loss of connection or the like. By way of example, exemplary techniques for generating an encryption key and an authentication code key at least partially based upon a common generic key counter will be hereinafter described in conjunction with each of these situations. However, other embodiments of the method, apparatus and computer program product may permit an encryption key and an authentication code key to be generated at least partially based upon a common generic key counter in other situations and by other devices, if so desired.

As shown in FIG. 4, during the initial network entry of a mobile station 10 with a network 12, in particular, with a base station 14 that will serve the mobile station and following an initial ranging operation or basic capability negotiations that includes a security capability negotiation, an initial authentication operation may be performed by the mobile station, the base station and the authenticator 16 followed by an 3-way handshake operation between the mobile station and the base station. It is noted that although FIG. 4 depicts the initial ranging to include a security capability negotiation, the security capability negotiation need not be including in the initial ranging and could, instead, be included in the basic capability negotiation, such as in the 802.16e specification. Following the initial authorization, but prior to the 3-way handshake, both the mobile station and the base station may locally generate an authentication code key, e.g., a CMAC key, utilizing the same predefined generic key counter value, such as 1. By generating the authentication code key prior to the 3-way handshake operation, the authentication code key may be utilized to protect the 3-way handshake messages, such as the SA-TEK challenge, request and response messages.

Following the 3-way handshake, the encryption keys may be locally generated by each of the mobile station 10 and the base station 12. In one embodiment, in addition to the generic key counter value, a nonce value may be utilized in the generation of the encryption key. The nonce parameter may be generated at different points during the process of initially authenticating the mobile station. In the illustrated embodiment, the mobile station or base station may initially generate the nonce value and may then provide the nonce value to the other during the 3-way handshake exchange. Alternatively, the nonce parameter may be provided during the ranging process, such as via RNG-REQ or RNG-RSP messages.

Following authentication, the respective processors 30, 60 of each of the mobile station 10 and the base station 14 may define a generic key counter. As described below and based upon the generic key counter, the mobile station and the base station of embodiments of the present invention may define not one, but a pair of generic key counter values, referenced herein as the first and second generic key counter value. For example, the mobile station and base station may each initially define the generic key counter to be a predefined value, such as 1. Based upon the predefined value of the generic key counter, the mobile station and the base station may each also define first and second generic key counter values. In one embodiment, for example, the first generic key counter value may be one less than the generic key counter, while the second generic key counter value may equal the generic key counter. By way of example in which the generic key counter is N, the CMAC key may be generated first using a generic key counter having the value N, but TEKs would be generated with generic key counter values of N and N-1. However, the generic key counter values shall be incremented prior to generation of the encryption keys and the authorization code keys so that neither the CMAC keys nor TEKs is generated with the same generic key counter values within the same AK. Based upon the generic key counter values, the respective processors of each of the mobile station and the base station may locally generate first and second encryption keys, such as first and second TEKs (e.g., older and newer generations) designated herein as TEK0 and TEK1. In this regard, the respective processors of the mobile station and the base station may generate TEK0 and TEK1 as follows:

TEK0=Dot16 kDF (AK, Key Counter=0, Nonce, SAID, “TEK”,128)−older generation

TEK1=Dot16 kDF (AK, Key Counter=1, Nonce, SAID, “TEK”,128)−newer generation

In this regard, the DOT16 KDF algorithm is defined by the 801.16e/Rev2 specification (see, for example, chapter 7.5.4.6.1). Moreover, SAID is defined as a security association (SA) identity. Although not described above, the TEKs may also be based upon the mobile station MAC address, BS ID and other parameters, if so desired.

In addition to the TEKs, the respective processors 30, 60 of the mobile station 10 and the base station 14 may also generate other encryption keys, such as the GTEK, at least partially based upon a generic key counter, albeit generally a different generic key counter than that described above in conjunction with the generation of the TEKs and the CMAC keys, in accordance with embodiments of the present invention. In this regard, the GTEK may be based upon a different generic key counter since the GTEK may be updated at a different time than the TEKs. Although the GTEK may be generated in various manners, the method of one embodiment may commence with the delivery of a new group authorization key (GAK) from the base station to the mobile stations within the group. It is noted that GAK may replace GKEK as defined in the 802.16e/Rev2 specification. The base station may also optionally deliver a nonce to the mobile stations in the group. The base station and each mobile station within the group may then reset the group generic key counter to a predefined value, such as 0. For example, the GTEK of one embodiment may be generated in the manner set forth below:

GTEK=Dot16 KDF (GAK, Key Counter, Nonce, SAID, “GTEK”, 128)

Prior to the end of the GTEK lifetime, the base station 12 may send a group key update message including a new nonce to the group of mobile stations 10. The base station and each mobile station within the group may then locally update, e.g., increment, the group generic key counter and then generate a new GTEK. This updating procedure may then be repeated until the base station provides a new GAK at which point the group generic key counter may be reset to the predefined value and the overall process may recommence. If an additional mobile station joins the group, the base station may provide the current GAK, nonce and group generic key counter to the joining mobile station. Conversely, the handover of a single mobile station will not affect the group generic key counter value.

As described above and in accordance with embodiments of the present invention, the encryption keys, such as the TEKs and the GTEK, may be locally generated by each of the base station 14 and the mobile station 10. In contrast, the 802.16e specification described the base station to generate the encryption keys and to then securely transmit the encryption keys to the mobile station. As such, embodiments of the method, apparatus and computer program product may provide more security in the generation of the encryption keys by avoiding any transmission of the encryption keys between the various entities.

In addition to the generation of one or more encryption keys, the method, apparatus and computer program product of embodiments of the present invention may also generate an authentication code key, such as one or more CMAC keys, during an initial authentication procedure. In this regard, the respective processors 30, 60 of the mobile station 10 and the base station 14 of one embodiment may generate the CMAC keys in accordance with the algorithms defined by the 802.16m specification, albeit based at least partially upon the generic key counter such as, for example, the first and second generic key counter values as follows:

CMAC_PREKEY_U | CMAC_PREKEY_D = Dot16KDF
(AK, “CMAC_KEYS”, 256)
CMAC_KEY_U/DO = AESCMAC_PREKEY_U/D
(Key Counter = 0) - older generation
CMAC_KEY_U/D1 = AESCMAC_PREKEY_U/D
(Key Counter = 1 - newer generation

As noted above, the method, apparatus and computer program product of embodiments of the present invention may not only base the generation of the authentication code keys, such as the CMAC keys, upon the generic key counter, but also upon other parameters, such as the mobile station nonce, MAC address, BS ID etc. As shown in FIG. 4, the encryption keys may be generated following successful authentication of the mobile station 10 during which the authentication key (AK) context becomes valid, that is, following a successful three-way handshake. However, the authentication code keys, such as the CMAC keys, may be generated prior to the three-way handshake and, indeed, may be utilized during the authentication process, such as during the PKMv2 SA three-way handshake messages, as noted above.

As described above, a nonce value may also be defined, such as by the mobile station 10 or base station 14, and then employed to generate the encryption keys. Also, the nonce may be used to generate the authentication codes, if the nonce is available prior to the need for message authentication. While the definition and provision of a single nonce value was described above, first and second nonces may be defined for use in conjunction with the generation of the first and second encryption keys, respectively. Moreover, while the CMAC keys were described above to not only be based upon the generic key counter, but also the nonce value (and other parameters), the CMAC keys of other embodiments need not be dependent upon the nonce value.

Following the initial authentication process, the authenticator 16 may also be configured to set the key counter value for the respective mobile station 10 to 1. In this regard, it is noted that the authenticator sets the key counter value to equal the generic key counter utilized during the initial authentication process. In accordance with the WiMAX 802.16m specification, for example, the authenticator may designate the general key counter as CMAC_KEY_COUNTER, which is set to 1 following initial authentication.

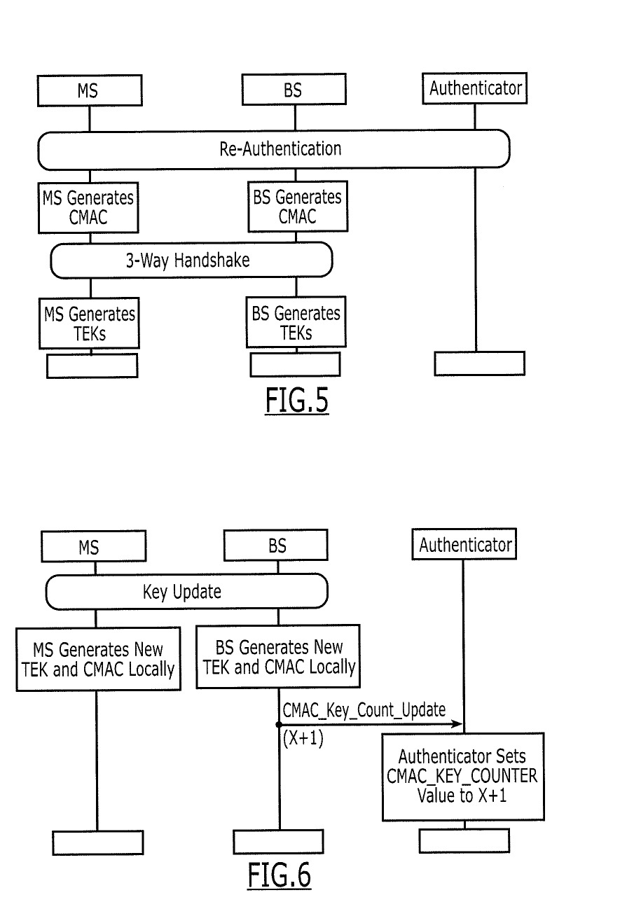

As shown in FIG. 5, the method, apparatus and computer program product of embodiments of the present invention may also generate encryption keys and authentication code keys during the re-authentication of a mobile station 10, which initializes the generic key counter and occurs prior to the exhaustion of the generic key counter space. By way of example, a mobile station, base station 14 and authenticator 16 may initially engage in a re-authentication process when a new AK context becomes valid following a successful three-way handshake. Following an initial re-authentication process, the mobile station and the base station may each generate an authentication code key, such as CMAC keys, based upon a generic key counter that has been set to a predefined value, such as 1. Thereafter, the mobile station or base station may allocate a nonce value and may exchange the nonce value with the other during the 3-way handshake, such as during a SA-TEK challenge procedure. Thereafter, the first and second generic key counter values may be defined based upon the generic key counter, such as by setting the first and second generic key counter values such as 0 and 1, respectively. The respective processors 30, 60 of the mobile station and the base station may then locally generate the encryption key, such as the TEKs, and the authentication code key, such as the CMAC keys, and the authenticator 16 may set the key counter to equal the generic key counter, e.g., 1, in the same manner as described above in conjunction with the initial authentication procedure of FIG. 4.

In the foregoing example, the generic key counter was set to a predefined value following the reauthentication procedure. For example, the generic key counter could be set to a predefined value, such as 0, upon reauthentication. Alternatively, the generic key counter may be set to a value, such as the smallest possible value, that permits the n-least significant bits of the generic key counter to be different than the n-least significant bits of the generic key counter utilized in conjunction with the prior AK.

As shown in FIG. 6, embodiments of the method, apparatus and computer program product may also generate an encryption key and authentication code key based upon a common generic key counter during a key update procedure. By way of example of a key update procedure, the mobile station 10 may initiate the key update procedure with the base station 14. Either the mobile station or the base station may allocate a new nonce value which may then be exchanged along with other parameters during a key update procedure, such as via key request and key reply signals. The respective processors 30, 60 of the mobile station and the base station then update the generic key counter, such as by increasing the generic key counter by one. In instances in which the generic key counter value is 1, the generic key counter may be incremented to have a value of 2. Thereafter, the respective processors of each of the mobile station and the base station may generate an encryption key and authentication code key based upon the updated generic key counter. In the embodiment having first and second encryption keys (termed the older and newer generation of encryption keys, respectively) and first and second authentication code keys (termed the older and newer generation of encryption keys, respectively), the newer generation encryption key and newer generation authentication code key are generated based upon the new generic key counter value, while the previous newer generation encryption key and the previous newer generation authentication code key may become the older generation of encryption and authentication code keys. As shown in FIG. 6, the updated generic key counter may also be provided by the base station to the authenticator 16 for storage, such as by setting the CMAC_Key_Counter parameter equal to the updated generic key counter.

Embodiments of the method, apparatus and computer program product may also generate an encryption key and authentication code at least partially based upon a common generic key counter in conjunction with a handover procedure. By way of example in regards to the handover methods supported by the 801.16m specification, the handover may occur with a break before entry, with entry before break or in an uncontrolled manner. In a break before entry handover procedure, the serving base station 14 may send a handover command (for example, corresponding to the MOB_BSHO-REQ/RSP messages defined in the 802.16e specification) to the mobile station 10 identifying the target base station. Alternatively, the handover command may include multiple target base stations. In this case, the mobile station may send a handover indication to the serving base station about the selection of a target base station (for example, corresponding to the MOB_HO-IND message defined in the 802.16e specification) The serving base station may then forward the context to the target base station prior to network reentry to the target base station.

In accordance with embodiments of the present invention, the mobile station 10, the serving base station 14 and each target base station may define or may otherwise be provided the generic key counter values to be utilized by each target base station. In one embodiment, the serving base station may send a list of target base stations to the mobile station, such as within the handover command (corresponding to the MOB_BSHO-REQ/RSP signals in the 802.16e specification). The mobile station and the base station may each then allocate a pair of generic key counter values for each potential target base station.

By way of example, in instances in which the list of target base stations includes two target base stations, that is, base station X and base station Y, and in which the current generic key counter value is N, the respective processors 30, 60 of the mobile station 10 and the serving base station 14 may be configured to assign first and generic key counter values of n+1 and n+2 to base station X and first and second generic key counter values of n+3 and n+4, respectively, to base station Y. Alternatively, the mobile station and the serving base station may be configured to allocate the same generic key counter values, such as n+1 and n+2, to each target base station, such as to each of target base stations X and Y.

As a further alternative, the serving base station 14 may prepare for handover with multiple target base stations via the backbone. In this preparatory stage, the serving base station may indicate the respective generic key counter values for each target base station, such as first and second generic key counter values of n+1 and n+2, respectively, for target base station X and first and second generic key counter values of n+3 and n+4, respectively, for target base station Y. Following the preparatory stage, the serving base station may select the most appropriate target base station and advise the mobile station 10 of the target base station, such as via the handover command (e.g., via the MOB_BSHO-REQ/RSP signals in the 802.16e specification). In conjunction with these signals, the serving base station may also advise the mobile station of the generic key counter value(s) of the target base station that has been selected.

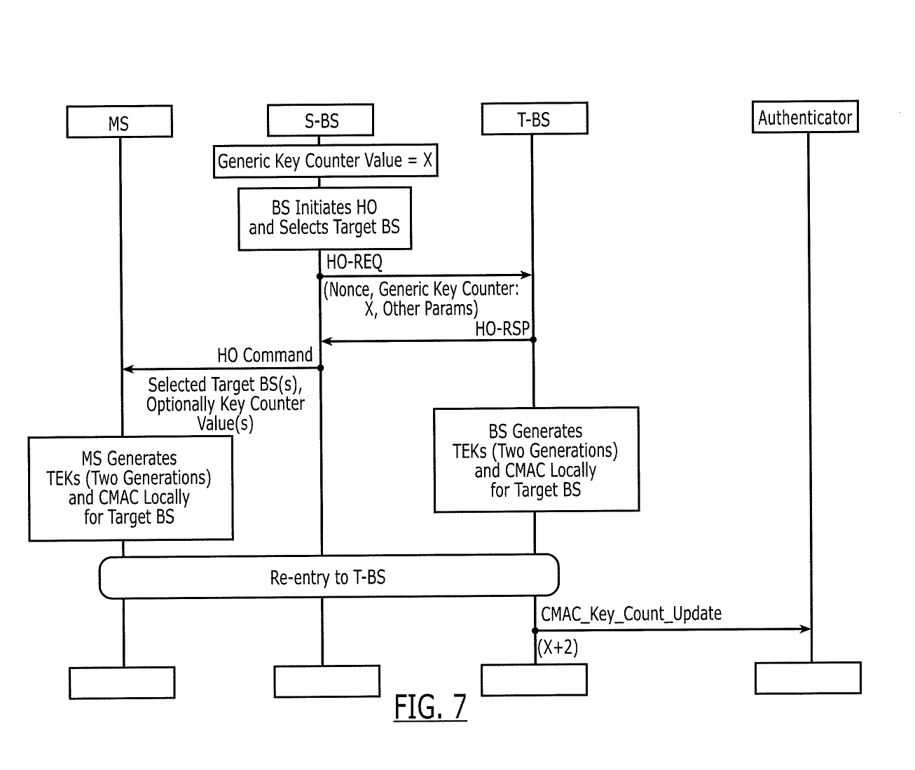

In this regard, FIG. 7 illustrates the process in which the serving base station 14 initiates the handover process and selects a target base station. In conjunction with the selection of the target base station and, in one embodiment, in response to receipt of a handover indication (such as a MOB_HO-IND signal as in the 802.16e specification) by the serving base station, the serving base station may provide the target base station with a plurality of parameters including the generic key counter value(s), the nonce and the like, such as via HO-REQ and HO-RSP signal exchange via backbone. In addition, the serving base station may advise the mobile station 10 via the HO command of the target base station that has been selected and the generic key counter value(s) of the selected target base station. Thereafter, the mobile station and the target base station may generate encryption keys and authentication code keys in a local manner as described above prior to network re-entry to the target base station. It is noted that the encryption keys and authentication code keys are generated by the mobile station and the target base station prior to completion of the re-entry to the target base station, thereby permitting data transmission to be resumed prior completion of network re-entry. In order to insure that different encryption keys and authentication code keys are generated, the generic key counter is increased prior to the generation of the encryption keys and authentication code keys. In one embodiment, the processor 60 of the serving base station increments the generic key counter prior to providing the generic key counter values to the target base station and the mobile station. In embodiments in which the serving base station does not provide the generic key counter values to the mobile station, however, the processor 30 of the mobile station may be configured to increment the generic key counter prior to generation of the encryption keys and the authentication code keys.

The processor 30 of the mobile station 10 may, but need not necessarily, generate a new nonce value as part of the handover re-entry process. If a new nonce is generated, the mobile station may provide the new nonce value to the target base station, potentially along with other parameters, such as via the RNG-REQ signals. Alternatively, the target base station may provide the mobile station with a new nonce, such as via the RNG-RSP signal. In either instance, re-entry to the target base station may thereafter be completed including the generation of new encryption keys and authentication code keys in the manner described above. Regardless of whether a new nonce is generated or not, the authenticator 16 may be advised by the target base station of the updated generic key counter value upon completion of the re-entry to the target base station.

As noted above, the handover may alternatively occur with entry before break. In this scenario, the process of selecting a target base station, updating the generic key counter value(s) and generating the encryption keys and authentication code keys can proceed as described above in conjunction with the embodiment of FIG. 7. It is noted, however, that this scenario permits communication to occur during the handover process simultaneously between the mobile station 10 and both the serving base station 14 and the target base station. As such, the communication between the mobile station and the serving base station may be conducted utilizing the encryption keys and the authentication code keys that existed prior to commencing the handover process, while the communication between the mobile station and the target base station may be conducted utilizing the new encryption keys and the authentication code keys that are generated during the handover process as described above (that is, the encryption keys and the authentication code keys that are generated utilizing the new generic key counter values that are assigned to the target base station).

In addition to handover that occurs as a break before entry and as an entry before break, an uncontrolled handover may occur in which the preparation phase is not executed. In this instance, a target base station may receive a request, such as an RNG-REQ signal, from an unknown mobile station 10, that is, a mobile station for which the temporary MSID or MAC address are unknown, or the target base station does not have the security context. The target base station may fetch the required information from the serving base station assuming that the request signal, such as the RNG-REQ signal, identifies the serving base station, such as by providing the BSID of the serving base station or the handover identification, e.g. HO_ID. If the target base station fails to validate the CMAC value in the request signal, such as the RNG-REQ signal, the target base station may transmit a response, such as a RNG-RSP signal, to indicate that full re-authentication is necessary. It is also noted that data transmission may generally only resume after the security context, including the generic key counter and the nonce, has been successfully fetched by the target base station.

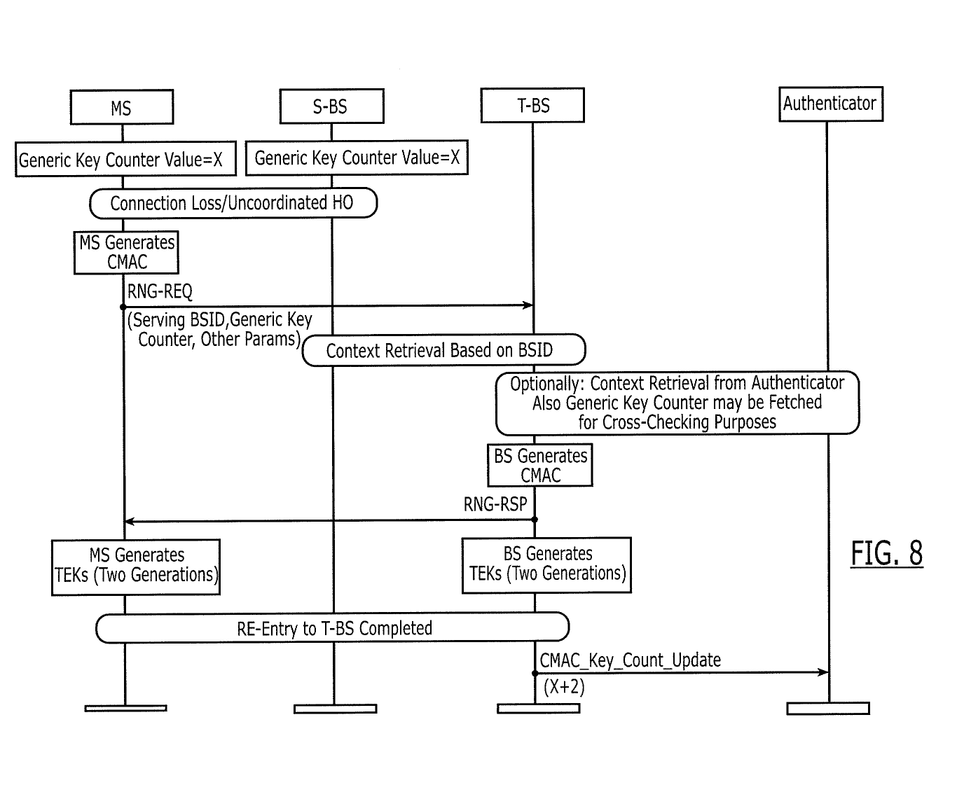

A method, apparatus and computer program product of embodiments of the present invention may also provide for the generation of encryption keys and authentication codes based at least partially upon common generic key counter value in instances of network re-entry, such as re-entry following a connection loss or drop or an idle mode re-entry. As shown in FIG. 8, following a connection loss or an uncoordinated handover, the mobile station 10 may update, e.g., increment, the generic key counter and then generate an authentication code key, such as CMAC keys, based upon the updated generic key counter when network re-entry will be made to a new base station (different to the serving base station during connection loss). In embodiments in which the mobile station makes the nonce allocation and then exchanges the nonce with ranging signals, the mobile station may allocate a nonce value and then transmit a request signal, such as a RNG-REQ signal, to a target base station to provide the generic key counter, the nonce and other parameters, such as the serving BSID. The target base station may then retrieve the context from the serving base station 14 as identified by the BSID, along with the generic key counter value(s). As shown in FIG. 8, the target base station may also optionally retrieve the context from the authenticator 16 including, for example, the generic key counter value(s). The generic key counter values retrieved from the serving base station and the authenticator may be compared by the processor of the target base station for cross checking purposes. However, if re-entry is made to the same base station which was the serving base station during the connection loss, then the generic key counter need not be incremented and thus new TEKs and CMAC need not be generated.

The target base station may then generate an authentication code key, such as CMAC keys, and then respond to the mobile station 10, such as via an RNG-RSP signal, with an indication of success or failure. If the context retrieval fails, the target base station may inform the mobile station that the initial network entry procedure and thus initial authentication should, instead, be executed. In instances in which the target base station has been successful in retrieving the context, however, the respective processors of the mobile station and the target base station may then each locally generate the encryption keys and the authentication code keys in the manner described above prior to completing re-entry to the target base station. As noted above, the respective processors of the base station and the target base station may update the generic key counter prior to the generation of the authentication code keys. As such, the target base station may update the generic key counter that are maintained by the authenticator 16. Although the mobile station was described in the foregoing embodiment to provide the nonce, the target base station of another embodiment may provide the nonce, along with other parameters such as a temporary MSID, to the mobile station.

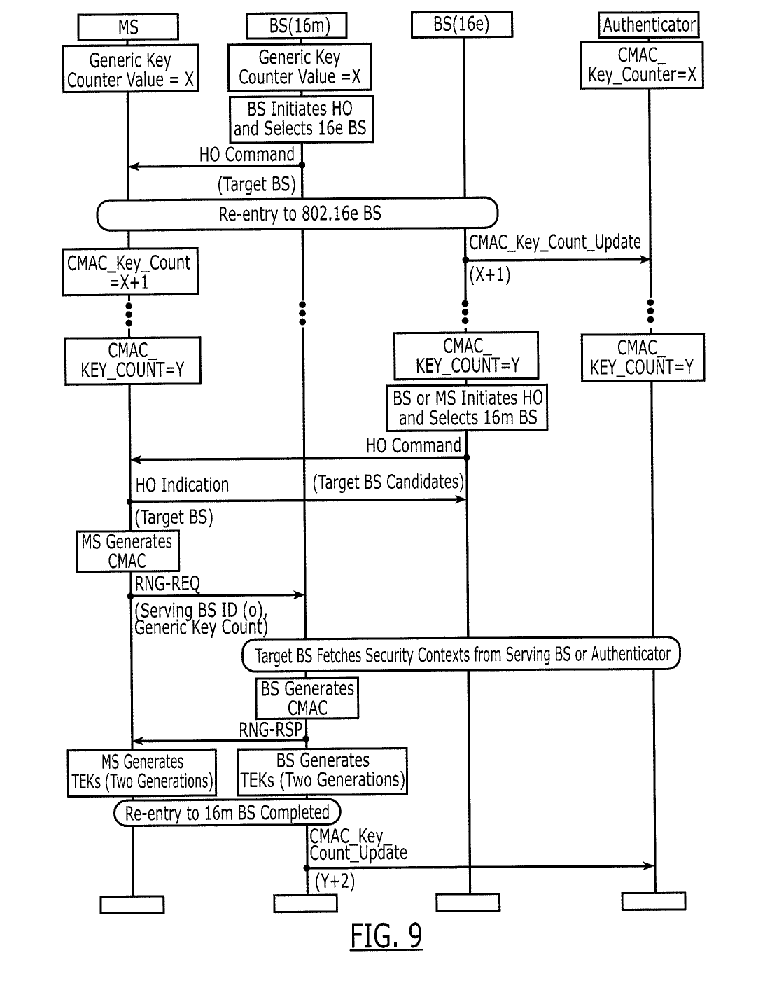

With reference to FIG. 9, embodiments of the method, apparatus and computer program product may also support handover from a base station operating in accordance with a first standard to a base station operating in accordance with a second standard and then returning to a base station operating in accordance with the first standard. Although the base stations may operate in accordance with various standards, this embodiment of the method, apparatus and computer program product will be described for purposes of illustration, but not of limitation, in conjunction with a handover from a base station operating in accordance with the 802.16m specification to a base station operating in accordance with the 802.16e specification and then back to a base station operating in accordance with the 802.16m specification.

During the handover between a base station operating in accordance with the 802.16m specification and a base station operating in accordance with the 802.16e specification, the nonce and the generic key counter value cannot be exchanged between the base stations. However, it is desirable to avoid reuse of the same encryption key and authentication code key in the final handover to the base station operating in accordance with the 802.16m specification. In one embodiment, upon the final handover back to the base station operating in accordance with the 802.16m specification, encrypted data transmission may resume only following the generation of a new nonce and its exchange between the mobile station and base station operating in accordance with the 802.16m specification. With respect to the authentication code key, such as the CMAC keys, the authentication code keys may be generated utilizing generic key counter values that are updated to and maintained by the authenticator 16 as a CMAC Key Counter. As such, when the mobile station is in communication with the base station operating in accordance with the 802.16e specification, the mobile station can generate the authentication code key utilizing a generic key counter equal to the CMAC_Key_Counter as maintained by the authenticator and as increased by the rules of the 802.16e specification. However, upon re-entry to communication with the base station operating in accordance with the 802.16m standard, the mobile station may generate the authentication code keys utilizing the same generic key counter values which the base station operating in accordance with the 802.16m standard may fetch from the authenticator in the form of the CMAC Key Counter values.

In this regard, FIG. 9 illustrates the selection of the 802.16e base station by the 802.16m base station and the notification of the mobile station 10, such as via an HO command, of the target base station. The re-entry to the 802.16e base station may then be completed according to the 802.16e specification with the encryption keys, such as the TEKs, and the authentication code keys, such as the CMAC keys, being generated in exchange in accordance with the rules of the 802.16e standard. In this process, both the generic key counter and the CMAC Key_Counter maintained by the authenticator 16 may be updated, such as by being incremented. Thereafter, while the mobile station is in communication with the 802.16e base station, further updates to the generic key counter and the CMAC_Key_Counter may be performed in the manner dictated by the 802.16e specification, such as in response to a handover from a first 802.16e base station to a second 802.16e base station. In order to handover to the 802.16m base station, either the 802.16e base station or the mobile station may initiate the handover and may select the 802.16m base station such that preparation for the handover to the 802.16m base station may then occur, such as via HO Command and HO Indication signals. Thereafter, the mobile station or base station may allocate or define a new nonce value and then each may generate the encryption keys and authentication code keys locally. In the illustrated embodiment, the mobile station may define a new nonce and then generate the authentication code keys based upon generic key counter values that are based upon the CMAC_Key_Counter maintained by the authenticator (generally following updating by the mobile station). In this regard, the mobile station may already hold the CMAC Key_Counter value. In one embodiment in which the the CMAC Key Counter value is Y, the processor 30 of the mobile station may be configured to define the first and second generic key counter values to be Y+1 and Y+2, respectively.

The mobile station 10 may then communicate with the 802.16m base station, such as via an RNG-REQ signal, to provide the generic key counter, nonce and other parameters. If not provided by the mobile station, the 802.16m base station may then fetch the CMAC_Key_Counter from the authenticator 16 and then update the generic key counter in the same manner as the mobile station. The 802.16m base station may also fetch other security context from the authenticator and may then generate the authentication code keys locally in the manner described above, that is, utilizing generic key counter values that are based upon the CMAC_Key_Counter values maintained by the authenticator 16 and that are updated by the 802.16m base station in the same manner as described above in conjunction with the mobile station. If the context retrieval is successful, the 802.16m base station may then advise the mobile station, such as via an RNG-RSP signal, of the status along with the nonce and other parameters, such as a temporary MSID. The mobile station and the 802.16m base station may then generate the encryption keys in the same manner as described above based upon the updated generic key counter. The re-entry of the mobile station to the 802.16m base station may then be completed and the 802.16m base station may update the CMAC_Key_Counter of the authenticator, such as to be Y+2 in the foregoing example. Alternatively, if the 802.16m base station was unsuccessful in fetching the generic key counter and other security context from the authenticator, the 802.16m base station may advise the mobile station that an initial network entry procedure must be followed.

Unlike the authentication code keys, the encryption keys may be specific to each security association (SA). Since a mobile station 10 may have several SAs, several generic key counters may be maintained by the mobile station and the base station with each generic key counter associated with a different SA. For example, a first generic key counter may be used in conjunction with the generation of the CMACs as well as the TEKs for SA1 (i.e., the primary SA), a second generic key counter may be used in conjunction with the generation of the TEKs for SA2 and a third generic key counter may be used in conjunction with the generation of the GTEKs for a group having SA1.

In conjunction with the transition from an 802.16e base station to an 802.16m base station in accordance with the embodiment of FIG. 9, the generic key counter for the primary SA may be defined based upon the CMAC_Key_Counter as described above. If the mobile station 10 has other SAs, the generic key counter(s) associated with the other SA(s) may be defined in various manners. For example, the mobile station may utilize the generic key counter(s) associated with the other SA(s) that were in effect during the prior service by the 802.16m base station (that is, prior to the transition to the 802.16e base station). In this embodiment, however, the generic key counter(s) associated with the other SA(s) may be updated prior to the generation of encryption keys. Alternatively, the generic key counter(s) associated with the other SA(s) may be reset to a predefined value, such as 0, and the desired uniqueness of the encryption keys may then be insured by providing unique nonces for each SA prior to generation of the encryption keys.

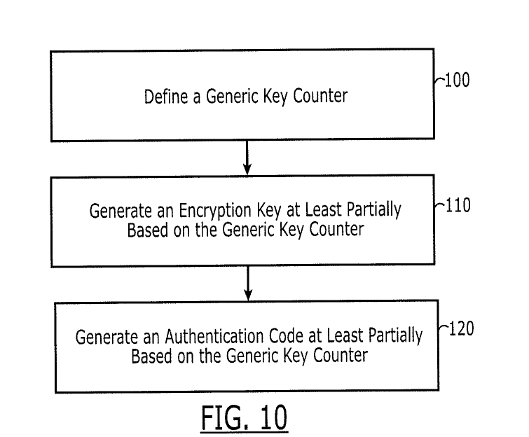

As described below, FIG. 10 is a flowchart of a system, method and program product according to some exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, base station or other apparatus employing embodiments of the present invention and executed by a processor in the mobile terminal, base station or other apparatus. In this regard, the operations described above in conjunction with the signal flow diagrams of FIGS. 4-9 may have been described as being performed by the mobile station, the serving base station, the target base station and/or the authenticator 16, but any or all of the operations may actually be performed by the respective processors of these entities, for example in response to computer program instructions executed by the respective processors. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowcharts block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for generating an encryption key and an authentication code based at least partially upon a generic key counter is illustrated, for example, in FIG. 10 from the perspective of either mobile station 10 or a base station 14. As shown, a generic key counter may be generated as shown in operation 100. In one embodiment, for example, first and second generic key counter values may be generated. As shown in operations 110 and 120, an encryption key may then be generated at least partially based upon the generic key counter and an authentication code key may also be generated, for example concurrently with the encryption key, that is at least based upon the same generic key counter. In one embodiment that utilizes first and second generic key counter values, first and second encryption keys may be generated based at least partially upon the first and second generic key counter values, respectively, and first and second authentication code keys may be generated that are also at least partially based upon the first and second generic key counter values, respectively. As will be recognized, more specific implementations of the method depicted in FIG. 10 may be employed in various scenarios including, for example, those depicted in FIGS. 4-9 and described above.

In an exemplary embodiment, an apparatus for performing the method of FIG. 10 above may include a processor (e.g., the processor(s) 30 and/or 60) configured to perform some or each of the operations (100-120) described above. The processor(s) may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor(s) 30 and/or 60 as described above.

Embodiments of the method, apparatus and computer program product may therefore permit an encryption key and an authentication code key to be generated based upon the same generic key counter, thereby providing potentially greater uniformity between the encryption keys and the authentication code keys as well as potentially reducing the processing resources that are consumed by the generation and maintenance of the encryption keys and authentication code keys. Further, some embodiments of the method, apparatus and computer program product may permit the encryption key and the authentication code key to be concurrently updated, thereby potentially further increasing the uniformity between the generation and maintenance of an encryption key and an authentication code key. This generation of the encryption key and the authentication code key based upon a common generic key counter may be performed in various situations including those described above in conjunction with FIGS. 4-9 as well as potentially other scenarios.

Many modifications and other embodiments of the inventions set forth herein will come to mind to one skilled in the art to which these inventions pertain having the benefit of the teachings presented in the foregoing descriptions and the associated drawings. For example, while embodiments of the present invention have been described in conjunction with the WiMAX 802.16e and 802.16m specifications, the embodiments of the present invention may be employed in conjunction with other protocols or the like. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
defining a generic key counter;
generating an encryption key at least partially based upon the generic key counter; and
generating an authentication code key that is also at least partially based upon the same generic key counter.

2. A method according to claim 1 wherein generating the encryption key further comprises generating the encryption key at least partially based upon both a nonce and the generic key counter.

3. A method according to claim 1 wherein defining a generic key counter comprises defining first and second generic key counter values based upon the generic key counter, wherein generating an encryption key comprises generating first and second encryption keys at least partially based upon the first and second generic key counter values, respectively, and wherein generating an authentication code key comprises generating at least one authentication code key at least partially based upon at least one of the first and second generic key counter values.

4. A method according to claim 3 wherein at least one authentication code key comprises generating first and second authentication code keys at least partially based upon the first and second generic key counter values, respectively.

5. A method according to claim 3 further comprising defining first and second generic key counter values for each target base station identified during a handover procedure, wherein the first and second generic key counter values are different for each target base station.

6. A method according to claim 3 further comprising defining first and second generic key counter values for each target base station identified during a handover procedure, wherein the first and second generic key counter values are identical for each target base station.

7. A method according to claim 1 further comprising updating the encryption key and the authentication code key in conjunction with at least one of a key update procedure or a handover procedure.

8. A method according to claim 1 further comprising initializing the generic key counter in conjunction with a reauthentication procedure.

9. A method according to claim 1 further comprising defining a group generic key counter and generating a group encryption key at least partially based upon the group generic key counter.

10. An apparatus comprising:
a processor configured to define a generic key counter,
wherein the processor is also configured to generate an encryption key at least partially based upon the generic key counter, and
wherein the processor is further configured to generate an authentication code key that is also at least partially based upon the same generic key counter.

11. An apparatus according to claim 10 wherein the processor is configured to generate the encryption key at least partially based upon both a nonce and the generic key counter.

12. An apparatus according to claim 10 wherein the processor is configured to define first and second generic key counter values based upon the generic key counter, wherein the processor is also configured to generate first and second encryption keys at least partially based upon the first and second generic key counter values, respectively, and wherein the processor is further configured to generate at least one authentication code key at least partially based upon at least one of the first and second generic key counter values.

13. An apparatus according to claim 12 wherein the processor is configured to generate at least one authentication code key by generating first and second authentication code keys at least partially based upon the first and second generic key counter values, respectively.

14. An apparatus according to claim 12 wherein the processor is configured to define the first and second generic key counter values for each target base station identified during a handover procedure, wherein the first and second generic key counter values are different for each target base station.

15. An apparatus according to claim 12 wherein the processor is configured to define the first and second generic key counter values for each target base station identified during a handover procedure, wherein the first and second generic key counter values are identical for each target base station.

16. An apparatus according to claim 10 wherein the processor is further configured to update the encryption key and the authentication code key in conjunction with at least one of a key update procedure or a handover procedure.

17. An apparatus according to claim 10 wherein the processor is further configured to initialize the generic key counter in conjunction with a reauthentication procedure.

18. An apparatus according to claim 10 wherein the processor is also configured to define a group generic key counter and to generate a group encryption key at least partially based upon the group generic key counter.

19. A computer program product comprising at least one computer-readable storage medium having computer-executable program code instructions stored therein, the computer-executable program code instructions comprising:
program code instructions configured to define a generic key counter;
program code instructions configured to generate an encryption key at least partially based upon the generic key counter; and
program code instructions configured to generate an authentication code key that is also at least partially based upon the same generic key counter.

20. A computer program product according to claim 17 wherein the program code instructions configured to generate the encryption key are further configured to generate the encryption key at least partially based upon both a nonce and the generic key counter.

21. A computer program product according to claim 19 wherein the program code instructions configured to define a generic key counter are further configured to define first and second generic key counter values based upon the generic key counter, wherein the program code instructions configured to generate an encryption key are further configured to generate first and second encryption keys at least partially based upon the first and second generic key counter values, respectively, and wherein the program code instructions configured to generate an authentication code key are further configured to generate at least one authentication code key at least partially based upon at least one of the first and second generic key counter values.

22. A computer program product according to claim 21 wherein the program code instructions configured to generate an authentication code key are further configured to generate first and second authentication code keys at least partially based upon the first and second generic key counter values, respectively.

23. A computer program product according to claim 21 wherein the program code instructions configured to define the generic key counter are further configured to define the first and second generic key counter values for each target base station identified during a handover procedure, wherein the first and second generic key counter values are different.

24. A computer program product according to claim 21 wherein the program code instructions configured to define the generic key counter are further configured to define the first and second generic key counter values for each target base station identified during a handover procedure, wherein the first and second generic key counter values are identical.

25. A computer program product according to claim 19 further comprising program code instructions configured to update the encryption key and the authentication code key in conjunction with at least one of a key update procedure or a handover procedure.

26. A computer program product according to claim 19 further comprising program code instructions configured to initialize the generic key counter in conjunction with a reauthentication procedure.

27. A computer program product according to claim 19 further comprising program code instructions configured to define a group generic key counter and program code instructions configured to generate a group encryption key at least partially based upon the group generic key counter.

28. An apparatus comprising:
means for defining a generic key counter;
means for generating an encryption key at least partially based upon the generic key counter; and
means for generating an authentication code key that is also at least partially based upon the same generic key counter.
